(19) United States
(12) Patent Application Publication
(10) Pub. No.: US 2025/0328898 A1
(43) Pub. Date: Oct. 23, 2025

(54) DECENTRALIZED STORAGE OF TRANSACTION DATA

(71) Applicant: American Express Travel Related Services Company, Inc., New York, NY (US)

(72) Inventors: Joyce Chiang, Montville, NJ (US); Michael Concannon, New York, NY (US); Andras L. Ferenczi, Peoria, AZ (US); Nathaniel Grauman, South Orange, NJ (US); Mohammad N. Nauman, Peoira, AZ (US); Steven M. Preston, Brighton (GB)

(21) Appl. No.: 19/259,788

(22) Filed: Jul. 3, 2025

Related U.S. Application Data
(62) Division of application No. 16/654,747, filed on Oct. 16, 2019.

(51) Int. Cl. G06Q 20/38; G06Q 20/42

(52) U.S. Cl. CPC G06Q 20/3829; G06Q 20/3823; G06Q 20/3827; G06Q 20/425; G06Q 2220/00

(57) ABSTRACT

Disclosed are various embodiments for decentralized storage of transaction data. An authorization request for a transaction is received from a second computing device. The transaction is then authorized. In response to authorization of the transaction, a node representing the transaction can be generated. The node is then stored in a graph. Moreover, in response to authorization of the transaction, a response is provided to the second computing device. The response can include a transaction identifier.

### CROSS-REFERENCE TO RELATED APPLICATIONS

This application is a divisional of co-pending U.S. patent application Ser. No. 16/654,747, entitled “DECENTRALIZED STORAGE OF TRANSACTION DATA” and filed on Oct. 16, 2019, which is incorporated by reference as if set forth herein in its entirety.

### BACKGROUND

Information about payment card transactions, such as credit and debit card transactions, is often communicated using various industry standards. For example, the International Organization for Standards (ISO) has various standards (e.g., ISO 8583) which govern how information about payment card transactions can be transmitted between parties. However, some of these standards limit the type and amount of data that can be transmitted between parties to a payment card transaction. As a result, a merchant or service provider that initiates a payment transaction with a customer's credit or debit card (or similar payment instrument) may be limited in the type of data that can be provided to the payment processor or financial institution.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a pictorial diagram of an example user interface rendered according to various embodiments of the present disclosure.

FIG. 2 is a drawing of a network environment according to various embodiments of the present disclosure.

FIG. 3A is a drawing of one example of a data structure utilized in the network environment of FIG. 2 according to various embodiments of the present disclosure.

FIG. 3B is a drawing of a second example of a data structure utilized in the network environment of FIG. 2 according to various embodiments of the present disclosure.

FIG. 4 is a sequence diagram illustrating one example of functionality implemented as portions of the network environment of FIG. 2 according to various embodiments of the present disclosure

FIG. 5 is a sequence diagram illustrating one example of functionality implemented as portions of the network environment of FIG. 2 according to various embodiments of the present disclosure.

### DETAILED DESCRIPTION

Disclosed are various approaches for storing and transmitting transaction data in a decentralized manner. Transaction records can be stored in a decentralized data store, such as a blockchain or other distributed ledger. For example, after a payment card transaction is authorized, the issuer could create a record in the distributed ledger that represents the transaction. The merchant that requested authorization of the transaction could then update the record in the distributed ledger to include additional information regarding the transaction that is omitted from an authorization request, such as a line-item listing of items or services purchased, reservation numbers, order confirmation numbers, etc. Later, the issuer could retrieve this additional information regarding the transaction to provide it to the account holder. In the following discussion, a general description of the system and its components is provided, followed by a discussion of the operation of the same.

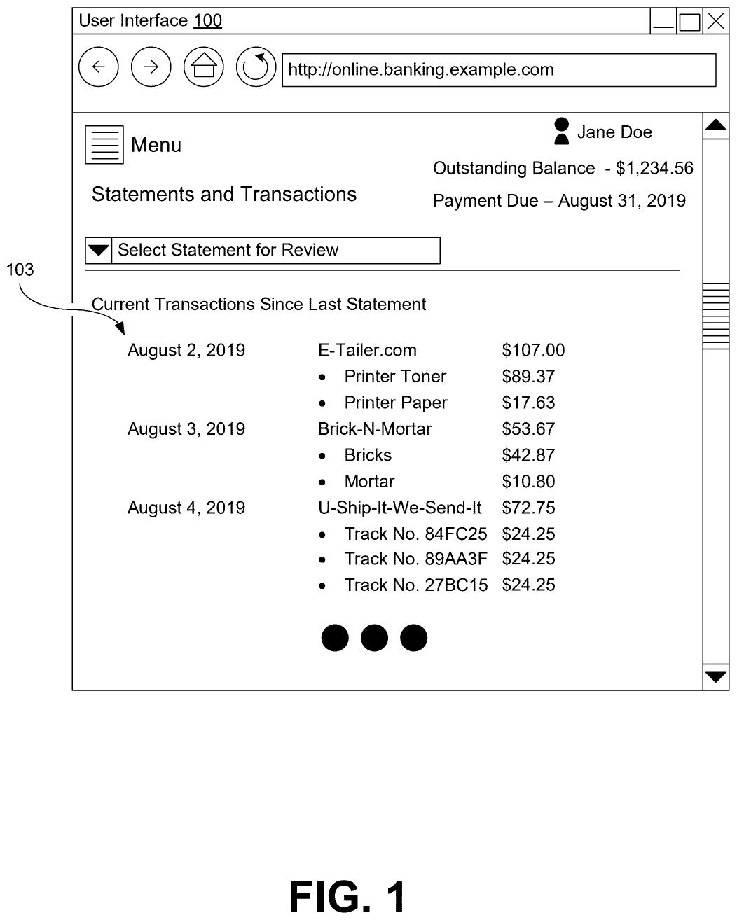

FIG. 1 depicts an example of a user interface 100 according to various embodiments of the present disclosure. The user interface 100 can be embodied, for example, as a web page within a browser window or window for a dedicated or stand-alone application. The user interface 100 can provide, for example, a view of a list of transactions 103. Each transaction can include additional data beyond what is typically presented to a customer in a statement of charges. For example, a typical statement might include the date, amount, and merchant with which a transaction occurred. However, the list of transactions 103 depicted in the user interface 100 can include enriched data for each transaction in the list of transactions 103, such as an itemized listing of individual charges for items or services, tracking numbers of shipments or orders, and potentially other information.

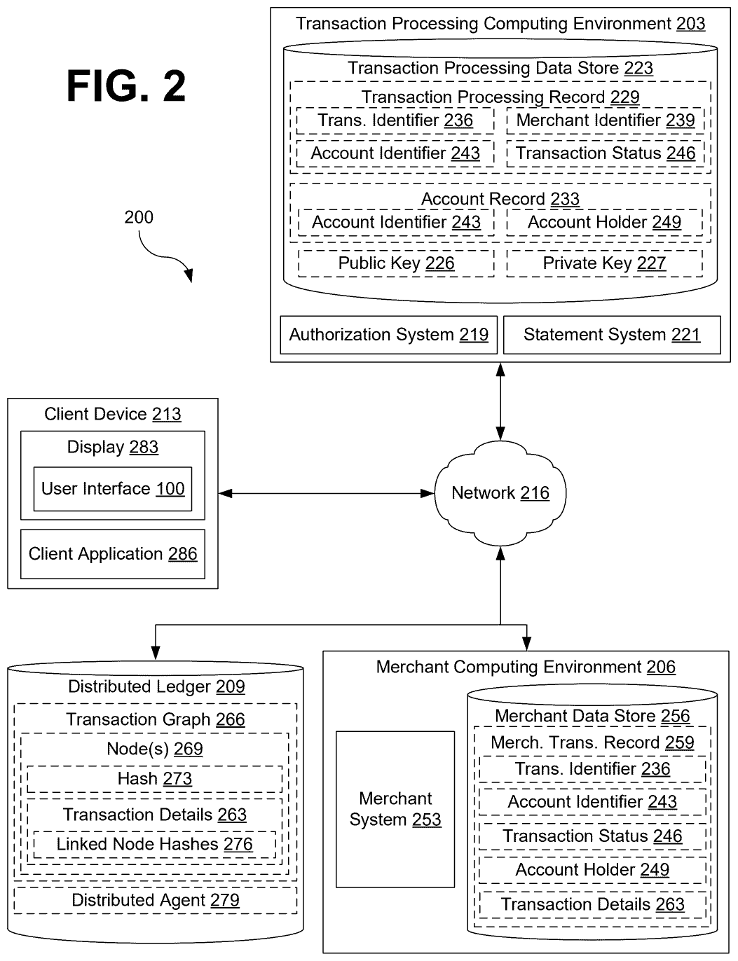

With reference to FIG. 2, shown is a network environment 200 according to various embodiments. The network environment 200 includes a transaction processing computing environment 203, a merchant computing environment 206, a distributed ledger 209, and a client device 213, which are in data communication with each other via a network 216. The network 216 can include wide area networks (WANs) and local area networks (LANs). These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 216 can also include a combination of two or more networks 216. Examples of networks 216 can include the Internet, intranets, extranets, virtual private networks (VPNs), and similar networks.

The transaction processing computing environment 203 and/or the merchant computing environment 206 can include a server computer or any other system providing computing capability. can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the transaction processing computing environment 203 and/or the merchant computing environment 206 can employ a plurality of computing devices that can be arranged in one or more server banks or computer banks or other arrangements. Such computing devices can be located in a single installation or can be distributed among many different geographical locations. For example, the transaction processing computing environment 203 and/or the merchant computing environment 206 can include a plurality of computing devices that together can include a hosted computing resource, a grid computing resource or any other distributed computing arrangement. In some cases, the transaction processing computing environment 203 and/or the merchant computing environment 206 can correspond to an elastic computing resource where the allotted capacity of processing, network, storage, or other computing-related resources can vary over time.

Various applications or other functionality can be executed in the transaction processing computing environment 203 according to various embodiments. The components executed on the transaction processing computing environment 203 include the authorization system 219, the statement system 221, and other applications, services, processes, systems, engines, or functionality not discussed in detail herein.

Also, various data is stored in a transaction processing data store 223 that is accessible to the computing environment 203. The transaction processing data store 223 can be representative of a plurality of transaction processing data store 223, which can include relational databases, object-oriented databases, hierarchical databases, hash tables or similar key-value data stores, as well as other data storage applications or data structures. The data stored in the transaction processing data store 223 is associated with the operation of the various applications or functional entities described below. This data can include a public key 226 and a respective private key 227, transaction processing records 229, account records 233, and potentially other data.

The authorization system 219 can be executed to authorize and/or process transactions involving a payment card (e.g., a debit or credit card transaction) initiated by the merchant computing environment 206. Accordingly, the authorization system 219 can analyze the information provided in the request to authorize the payment card transaction to determine the validity of the request, utilize one or more fraud detection systems to determine that the request is authentic, and then reach a decision regarding whether the payment card transaction will be processed. If the payment card transaction is to be processed, the authorization system 219 may also initiate the transfer of funds from the account of the customer to the account of the merchant. Likewise, if the payment card transaction will not processed, the authorization system 219 may provide a response to the merchant computing environment 206 indicating the reason the transaction was declined.

For example, an electronic commerce application hosted by the merchant computing environment 206 could send a request to the authorization system 219 for payment in connection with an order placed with the electronic commerce application. In such a card-not-present transaction, the electronic commerce application might provide the name of the account holder, account number, billing address associated with the account, expiration date of the account, a verification number associated with the account, and the amount funds requested as payment. The authorization system 219 could then verify that the provided information matches information on file with a customer account and authorize the transaction in response. In some instances, the authorization system 219 could also analyze the transaction itself to see if the transaction is similar to fraudulent transactions or authorized transactions. If the transaction is similar to authorized transactions, the authorization system 219 may use this criterion as a further basis for authorizing the transaction. Likewise, if the transaction is similar to fraudulent transactions, the authorization system 219 may use this criterion as a further basis for authorizing the transaction. A similar process can be used for a card-present transaction initiated by a point-of-sale (PoS) terminal.

The statement system 221 can be executed to collect and compile collections of transactions associated with a customer's account according to various criteria. For example, the statement system 221 could review one or more transaction processing records 229 associated with an account record 233 to generate a list of transactions 103. The list of transactions 103 could then be provided to a customer through various channels of communication (e.g., through the user interface 100 or through a paper statement mailed to the account holder). The list of transactions 103 could be generated according to various criteria (e.g., transactions occurring within a specified period of time).

A public key 226 and a private key 227, which may be part of a respective asymmetric encryption key-pair, can also be stored in the transaction processing data store 229. The public key 226 can be used by various applications or systems to encrypt data to be stored for later use by the statement system 221. Likewise, the private key 227 can be used by the statement system 221 to decrypt data used to generate the list of transactions 103.

A transaction processing record 229 can represent information associated with a specific transaction processed by the authorization system 219. Accordingly, a transaction processing record 229 can include a transaction identifier 236, a merchant identifier 239, an account identifier 243, a transaction status 246, and potentially other information, such as the amount of the transaction or the date and time that the transaction was processed or submitted for processing. The transaction identifier 236 can be any identifier that uniquely identifies a particular transaction with respect to other transactions. For example, the transaction identifier 236 could be represented as an alphanumeric sequence of characters, a sequentially increasing series of numbers, or any other suitably unique identifier. The merchant identifier 239 can be any identifier that uniquely identifies a particular merchant requesting authorization and/or processing of a transaction with respect to other merchants that might be requesting authorization and/or processing of other transactions. Examples of merchant identifiers 239 can include the name of the merchant, a unique number or alphanumeric character sequence assigned to the merchant, or other suitably unique identifiers. The account identifier 243 can be any identifier that uniquely identifies a financial account with respect to other financial accounts. An example of an account identifier 234 would be an account number issued by the institution maintaining the account on behalf of the account holder. The transaction status 246 can indicate the state of the transaction represented by the transaction processing record 229. Examples of transaction statuses 246 include states such as pending, approved, declined, and so forth.

An account record 233 can represent information associated with a particular financial account (e.g., demand deposit account or credit account). For example, the account record 233 can include an account identifier 243, an account holder 249 (e.g., the full legal name of the owner of the financial account), and potentially other information, such as the current account balance, an expiration date for the account, etc.

Various applications or other functionality can be executed in the merchant computing environment 206 according to various embodiments. The components executed on the merchant computing environment 203 can include a merchant system 253, and other applications, services, processes, systems, engines, or functionality not discussed in detail herein.

The merchant system 253 can be executed to collect payment information from customers and request authorization of payment using the payment information. The merchant system 253 may be executed as part of a larger application suite or system, such as an electronic commerce application or system. Such an electronic commerce application or system could be executed in order to facilitate the online purchase of items over the network 216. For example, the electronic commerce application or system could be executed to generate web pages or other types of content that are provided to client devices 213 for the purposes of selecting items or services for purchase, rental, download, lease, or other form of consumption. However, the merchant system 253 could also be implemented as a standalone application, such as one where payment information is entered by an employee of the merchant when processing an order placed over the phone or by mail-order. As another example, the merchant system 253 could be implemented as part of a point-of-sale (PoS) terminal or system used when a customer is able to physically present his or her debit or credit card to the merchant for payment.

Also, various data is stored in a merchant data store 256 that is accessible to the merchant computing environment 206. The merchant data store 256 can be representative of a plurality of merchant data stores 256, which can include relational databases, object-oriented databases, hierarchical databases, hash tables or similar key-value data stores, as well as other data storage applications or data structures. The data stored in merchant data store 256 is associated with the operation of the various applications or functional entities described below. This data can include one or more merchant transaction records 259, and potentially other data, such as information about particular products, items, or services provided by the merchant to customers. This additional information can include prices, stock keeping unit (SKU) numbers, and descriptions of the products, items, or services.

The merchant transaction record 259 can represent information available to a merchant about a particular payment card transaction. Some information associated with a merchant transaction record 259 may be known to both the merchant system 253 and the authorization system 219. This can include the transaction identifier 236, the account identifier 243, the transaction status 246, and the account holder 249, as well as the total amount of the transaction and/or the date and time that the transaction was submitted by the merchant system 253 to the authorization system 219 for processing. However, some additional information originally known exclusively to the merchant may also be included in the merchant transaction record 259, represented as transaction details 263.

The transaction details 263 represent the additional information known to the merchant system 253 about a particular transaction. This additional information can include the specific items or services purchased, including the quantity, price, name, description, and SKUs of purchased items or services. The transaction details 263 can also include information provided by the customer, such as a purchase order number, invoice number, tax-exempt status, etc. For example, if a passenger were purchasing an airline ticket, the transaction details 263 could include the price of the ticket, fare class (e.g., first class, business class, economy class, etc.), flight number, seat number, etc. As another example, if a customer were purchasing items from a store, the transaction details 263 could include the name, SKU, quantity, description, price of individual items purchased, and other information. As a third example, if a guest had booked a hotel room, the transaction details 263 could include the number of nights stayed, the price for each night, the type of room (e.g., regular, suite, etc.), as well as the name, SKI, quantity, description and price of individual room charges (e.g., room service meals, on-site restaurant meals, laundry service, etc.).

The distributed ledger 209 represents a synchronized, eventually consistent, data store spread across multiple nodes in different geographic or network locations. Each member of the distributed ledger 209 can contain a replicated copy of the distributed ledger 209, including all data stored in the distributed ledger 209. Records of transactions involving the distributed ledger 209 can be shared or replicated using a peer-to-peer network connecting the individual members that form the distributed ledger 209. Once a transaction or record is recorded in the distributed ledger 209, it can be replicated across the peer-to-peer network until the record is eventually recorded with all members. Various consensus methods can be used to ensure that data is written reliably to the distributed ledger 209. Examples of a distributed ledger can include blockchains, distributed hash tables (DHTs), and similar data structures.

Various data can also be stored in a distributed ledger 209. This can include the transaction graph 266. However, any other data discussed in the present disclosure could also be stored in the distributed ledger 209 if the public availability of the data were acceptable in that particular implementation. Moreover, it should be noted that while a distributed ledger 209 may be used to store the transaction graph 266, other types of data stores could be used. However, because of the resemblance of many distributed ledgers 209 to graphs, it may be convenient to use a distributed ledger 209 to store the transaction graph 266.

The transaction graph 266 can represent data related to one or more transactions processed by the transaction processing computing environment 203 on behalf of one or more merchants and/or customers. Accordingly, the transaction graph 266 can include one or more nodes 269 that represent individual transactions, including related transactions.

Each node 269 can represent information related to a transaction. Where multiple parties provide information related to a transaction, each party may update or add information to a node 269 representing a transaction. However, in some situations, parties may create and update separate nodes 269 related to a particular transaction. Information stored in a node 269 (e.g., by the authorization system 219 or a merchant system 253) may be encrypted using the public key 226 of the statement system 221. Such information could then be decrypted by the statement system 221 using the respective private key 227 when information stored in a node 269 is retrieved.

The hash 273 is a unique identifier for an individual node 269 within the transaction graph 266 that is based at least in part on one or more transaction details 263. Accordingly, the hash 273 can be used as a key for identifying an individual node 269 in the transaction graph 266. In simple implementations, the transaction identifier 236 could be used as the hash 273 for the purpose of uniquely identifying a node 269. In more complex implementations, however, the hash 273 could be computed using a cryptographic hash function that accepts the account identifier 243 and the transaction identifier 236 as arguments. In some implementations, the account holder 249 (e.g., the first name and the last name of the primary account holder) can also be used as additional arguments to the cryptographic hash function. As another example, the hash 273 could be implemented as tuple that includes one or more pieces of information, such as the account identifier 243, the transaction identifier 236, and/or the account holder 249.

Transaction details 263 stored in a node 269 can include the same or similar pieces of information as the transaction details 263 stored in the merchant transaction record 259 or the transaction processing record 229. In addition, the transaction details 263 can include one or more linked node hashes 276. The linked node hashes 276 can include the hashes 273 of other nodes 269 that contain additional information related to or regarding the transaction represented by the node 269. For example, if the node 269 represented a transaction with a travel agent, then a linked node hash 276 could include a hashes 273 for nodes 269 related to a hotel, car rental, or flight reservation.

The distributed agent 279 can represent a script or other executable which can be stored in the distributed ledger 209 and executed by individual hosts or peers of the distributed ledger 209. When a computation is performed by the distributed agent 279, each host or peer that forms the distributed ledger 209 can perform the computation and compare its result with the results computed by other hosts or peers. When a sufficient number of hosts or peers forming the distributed ledger 209 agree on the result of the computation, the result can be stored in the distributed ledger 209 or provided to the computing device that invoked the distributed agent 279. An example of a distributed agent 279 is a “smart contract” used in the ETHEREUM platform, although other distributed ledger or blockchain-based technologies provide similar functionality.

For instance, a distributed agent 279 could be programmed to manage the data stored within and the functionality provided by individual transaction graphs 266 and nodes 269 within a transaction graph 266. Accordingly, when provided with an appropriate hash 273 or collection of hashes 273, the distributed agent 279 could create a new transaction graph 266 that includes a root node 269, update a node 269 in an existing transaction graph 266 or add a new node 269 to a transaction graph 266 as a leaf of an existing node 269 in the transaction graph 266. As a result, while data written to and stored in the distributed ledger 209 may be immutable, transaction graphs 266 and nodes 269 can be updated with new information over time.

In some implementations, the distributed agent 279 could also be programmed to encrypt the content stored on the distributed ledger 209. For example, when a node 269 is created or updated using the distributed agent 279, the distributed agent 279 could encrypt the new or updated transaction details 263 prior to committing them to the distributed ledger 209. Accordingly, the distributed agent 279 may accept a public key 226 as an argument when a node 269 is created to allow or facilitate encryption or transaction details 263 stored in a node 269. However, in other implementations, the authorization system 219 or merchant system 253 may encrypt information with the public key 226 prior to storing the information in the node 269 or supplying the information to the distributed agent 279 for recording in a node 269.

The client device 213 is representative of a plurality of client devices that can be coupled to the network 216. The client device 213 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 213 can include one or more displays 283, such as liquid crystal displays (LCDs), gas plasma-based flat panel displays, organic light emitting diode (OLED) displays, electrophoretic ink (“E-ink”) displays, projectors, or other types of display devices. In some instances, the display 283 can be a component of the client device 213 or can be connected to the client device 213 through a wired or wireless connection.

The client device 213 can be configured to execute various applications such as a client application 286 or other applications. The client application 286 can be executed in a client device 213 to access network content served up by the statement system 221 or other applications, thereby rendering a user interface 100 on the display 283. To this end, the client application 286 can include a browser, a dedicated application, or other executable and the user interface 100 can include a network page, an application screen, or other user mechanism for obtaining user input. The client device 213 can be configured to execute applications beyond the client application 286 such as email applications, social networking applications, word processors, spreadsheets, or other applications.

Next, a general description of the operation of the various components of the network environment 200 is provided. Although the following general description illustrate an example operation, the individual components of the network environment 200 can interact with or operate in other manners. Example alternatives are identified in the accompanying discussion of subsequent figures.

To begin, a customer can initiate a transaction with a merchant. The transaction can be related to any item, service, or combination of items and services. For example, the customer could make a payment with a payment card account (e.g., credit card or debit card account) to rent or purchase an item or in exchange for services rendered by the merchant. As another example, the customer could request a refund to a previous purchase in exchange for a defective or unsatisfactory item or service experience.

In response, the merchant system 253 can request that an issuer of the payment card account to authorize the transaction. More specifically, the merchant system 253 can send a request to the authorization system 219 to authorize the transaction. The request can include information such as the account identifier 243 of the payment card account used, merchant identifier 239 for the merchant operating the merchant system 253, the amount of the transaction, and at least a portion of the identity of the account holder 249.

The authorization system 219 can then use the information provided by the merchant system 253 to determine whether to authorize the transaction. For example, the authorization system 219 may determine whether the account identifier 243 is valid, whether the account holder 249 is valid, or whether the transaction itself is similar to other fraudulent transactions. In response to authorizing the transaction, the authorization system 219 can create a transaction processing record 229 that represents the transaction. The authorization system 219 can also create a node 269 in the transaction graph 266 which represents the transaction. Then, the authorization system 219 can provide a response to the merchant system 253 indicating that the transaction was authorized.

Subsequently, the merchant system 253 can update the node 269 to include additional information about the transaction. For example, the merchant system 253 could add one or more transaction details 263 to the node 269. As another example, the merchant system 253 could add hashes 273 of related nodes 269 to the list of linked node hashes 276 stored with the node 269.

The statement system 221 can then query the transaction graph 266 to obtain the transaction details 263 associated with a transaction. The transaction details 263 could then be incorporated with the data in the transaction processing record 229 to create a combined representation of the transaction. This combination could then be included in a list of transactions 103, which could be provided to the user in response to a request for the list of transactions 103, such as a request from a client application 286 to see transactions that occurred during a particular period of time (e.g., during a previous month, billing period, quarter, etc.).

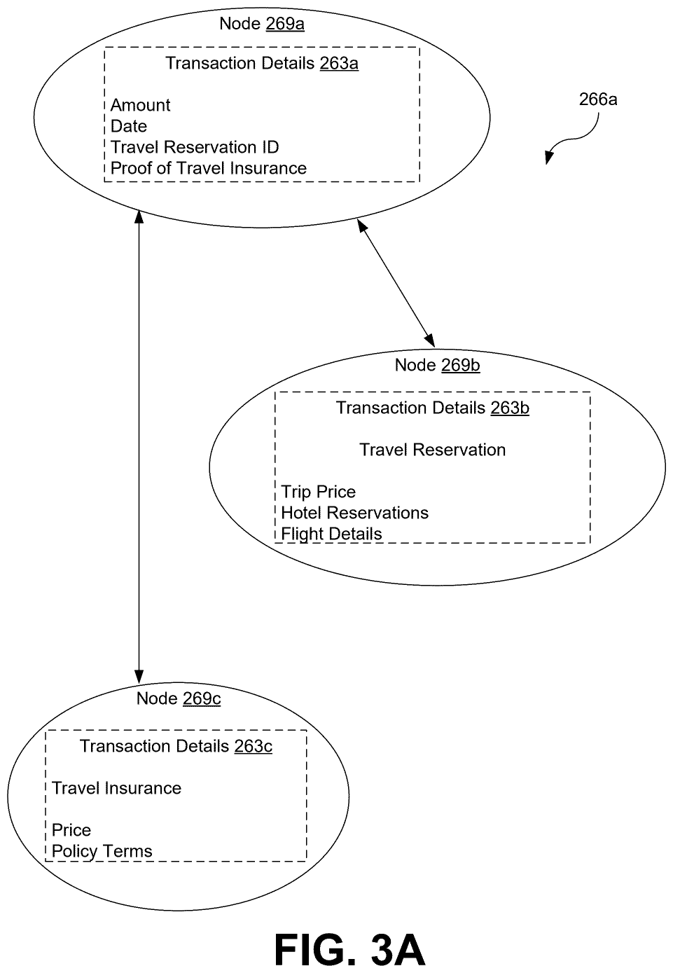

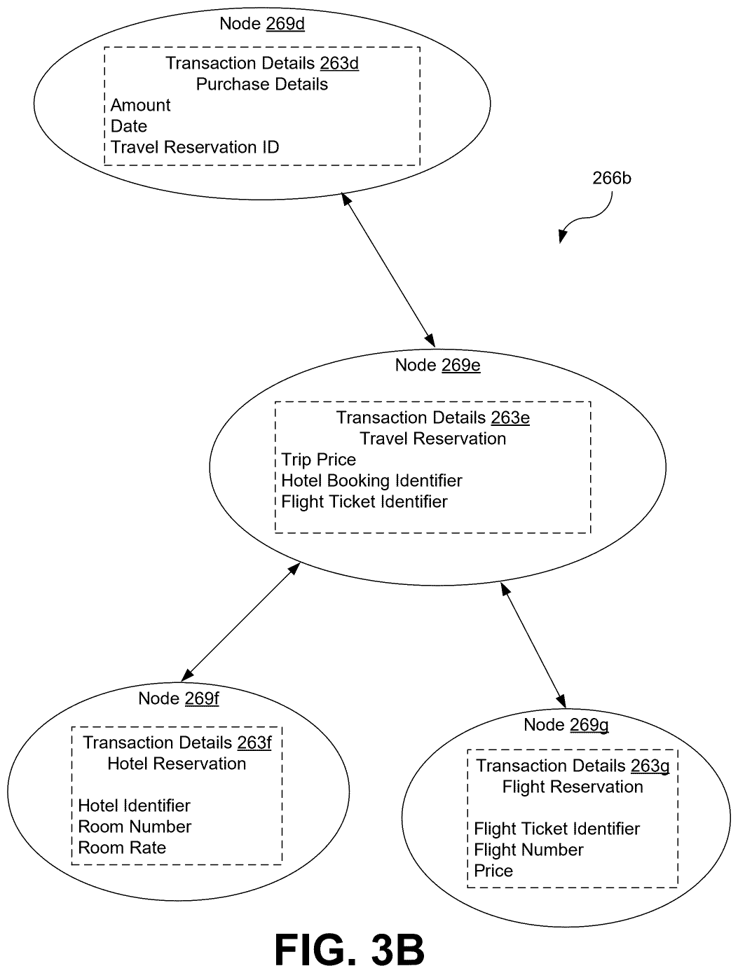

FIG. 3A provides one example of a transaction graph 266a that can be stored in the distributed ledger 209 according to various embodiments of the present disclosure. As illustrated, the transaction graph 266a include a number of nodes 269a, 269b, and 269c. Node 269a is the root node, while nodes 269b and 269c are leaf nodes 269 from node 269a. Although the transaction graph 266a shows one example of a transaction graph 266, it should be noted that the transaction graph 266a can have cycles and that the links can be unidirectional or bidirectional, depending on the particular instance.

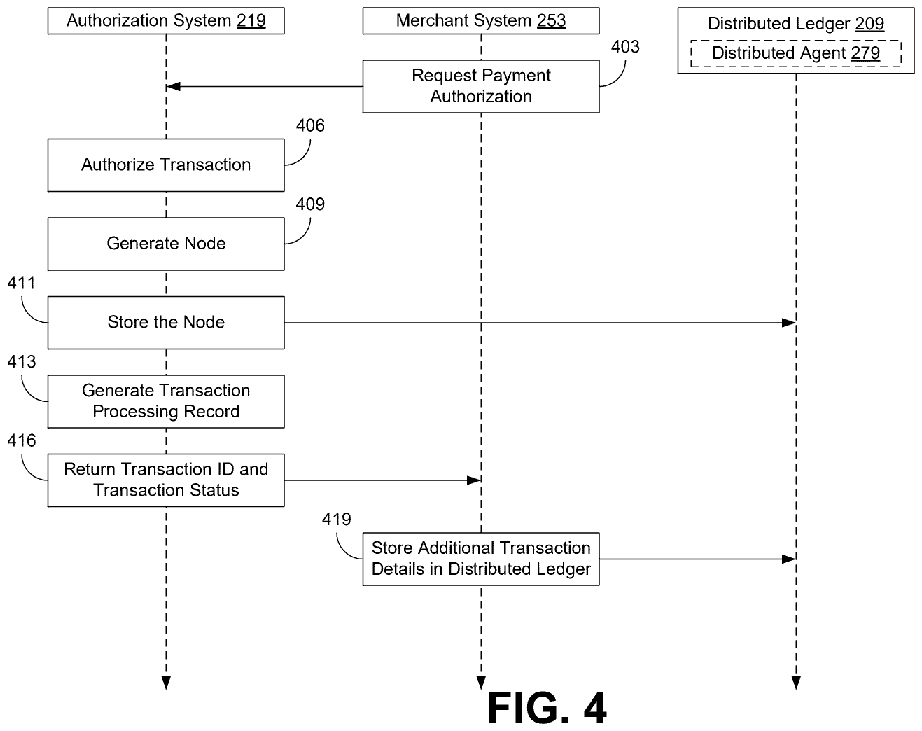

Node 269a can be created originally by the authorization system 219 as previously described and as described in further detail in the discussion of FIG. 4. For example, when the authorization system 219 first authorizes a transaction on behalf of a merchant system 253, the authorization system 219 can create the node 269a or cause it to be created by the distributed agent 279. The authorization system 219 can initially store one or more transaction details 263 in the node 269a, such as the amount and date of the transaction.

Subsequently, one or more merchant systems 253 can update the node 269a to include additional information about the transaction. For example, if a customer made a reservation with an online travel agency, then a merchant system 253 operated by an online travel agency might update the node 269a to include a travel reservation identifier for the online travel agency. The online travel agency's merchant system 253 could also add a hash 273 to the linked node hashes 276 of the root node 269a linking the root node 269a to a second node 269b, which could contain additional information about the reservation.

Node 269b could be created by a merchant system 253 once a transaction is completed with a respective merchant. For example, if a customer made a reservation with an online travel agency, the merchant system 253 operated by the online travel agency could create node 269b in response to a user making a reservation. Various transaction details 263b about the reservation could be stored in the node 269b. When the authorization system 219 sends a response to the merchant system 253 that payment is authorized, the merchant system 253 could then create a link between the nodes 269a and 269b. For example, the online travel agency's merchant system 253 could also add a hash 273 to the linked node hashes 276 of the root node 269a linking the root node 269a to a second node 269b.

Node 269c could be created by a second merchant system 253 for a second, related transaction. For example, if a customer had purchased travel insurance for his or her trip, the merchant system 253 for the travel insurance company might update the transaction details 269a in the node 269a to include information about the travel insurance policy, such as proof of insurance. The merchant system 253 for the travel insurance company could also add a second hash 273 to the linked node hashes 276 of the root node 269a to link the root node 269a to the node 269c, where transaction details 263c would provide more detailed information about the travel insurance policy, such as the price of the policy, the terms of the policy, etc.

FIG. 3B provides one example of a transaction graph 266b that can be stored in the distributed ledger 209 according to various embodiments of the present disclosure. As illustrated, the transaction graph 266b include a number of nodes 269d, 269e, 269f, and 269g. Node 269d is the root node, while node 269e is a leaf node 269 of node 269d. Meanwhile, nodes 269f and 269g are leaf nodes 269 from node 269e. Although the transaction graph 266b shows one example of a transaction graph 266, it should be noted that the transaction graph 266b can have cycles and that the links can be unidirectional or bidirectional, depending on the particular instance.

Node 269d can be created originally by the authorization system 219 as previously described and as described in further detail in the discussion of FIG. 4. For example, when the authorization system 219 first authorizes a transaction on behalf of a merchant system 253, the authorization system 219 can create the node 269d or cause it to be created by the distributed agent 279. The authorization system 219 can initially store one or more transaction details 263 in the node 269d, such as the amount and date of the transaction.

Subsequently, one or more merchant systems 253 can update the node 269d to include additional information about the transaction. For example, if a customer made a reservation with an online travel agency, then a merchant system 253 operated by an online travel agency might update the node 269d to include a travel reservation identifier for the online travel agency. The online travel agency's merchant system 253 could also add a hash 273 to the linked node hashes 276 of the root node 269d linking the root node 269d to a second node 269e, which could contain additional information about the reservation.

Node 269e could be created by a merchant system 253 once a transaction is completed with a respective merchant. For example, if a customer made a reservation with an online travel agency, the merchant system 253 operated by the online travel agency could create node 269e in response to a user making a reservation. Various transaction details 263e about the reservation could be stored in the node 269e. When the authorization system 219 sends a response to the merchant system 253 that payment is authorized, the merchant system 253 could then create a link between the nodes 269a and 269b. For example, the online travel agency's merchant system 253 could also add a hash 273 to the linked node hashes 276 of the root node 269a linking the root node 269a to a second node 269b.

Additional merchant systems 253 could then create and link additional nodes 269f and 269g to the node 269e. For example, a merchant system 253 operated by a hotel could create a node 269f that includes transaction details 263f related to the hotel reservation, such as the name and location of the hotel, room number, rate, etc. Meanwhile a merchant system 253 operated by an airline could create a node 269g that includes transaction details 269g related to the flight reservation, such as the ticket number, flight number, price, etc. This multi-tiered approach to the transaction graph 266b would allow for merchants that are third-parties to a transaction to be able to indirectly link information to the transaction.

Referring next to FIG. 4, shown is a sequence diagram that provides one example of the interaction between various components of the network environment 200. It is understood that the flowchart of FIG. 4 provides merely an example of the many different types of functional arrangements that can be implemented in the network environment 200. As an alternative, the flowchart of FIG. 4 can be viewed as depicting an example of elements of a method implemented within the network environment 200.

Beginning with block 403, the merchant system 253 can send a request for payment authorization to the authorization system 219. The request for payment authorization could be generated and sent by the merchant system 253 in response a customer request to purchase, rent, or otherwise consume goods or services. As one example, an electronic commerce system could send a request to authorize payment in response to a customer providing his or her credit or debit card information to the electronic commerce system to complete a purchase. The authorization request can include information such as the account identifier 243 and account holder 249 for a payment card account (e.g., credit or debit card), the merchant identifier 239 for the merchant requesting the payment authorization, and the amount of the transaction.

Next at block 406, the authorization system 219 can evaluate the request and authorize the transaction. The authorization system 219 could take a number of factors into account in determining whether to authorize the transaction. For example, the authorization system 219 can evaluate whether the account identifier 243 and account holder 249 are valid or accurate. As another example, the authorization system 219 can determine whether the amount of the transaction and/or merchant identifier 239 are similar to previous transactions made with the payment card account. For example, an abnormally large transaction, or a transaction with a merchant the account holder does not normally conduct business with, may indicate that a forged or stolen payment card is being used.

Assuming that the transaction is authorized, then the authorization system 219 can generate a node 269 at block 409 that represents the transaction. For example, authorization system 219 can generate a hash 273 that uniquely identifies the node 269 with respect to other nodes 269 that represent other transactions. To generate the hash 273, the authorization system 219 could use various approaches based at least in part on the information stored in the transaction processing record 229 associated with a given transaction. For example, the tuple formed by a number of parameters related to the transaction (e.g., transaction identifier 236, account identifier 243, account holder 246, etc.) could be used as a hash 273 for a transaction. As another example, the parameters related to the transaction could be concatenated together to form an input for a cryptographic hash function that would generate a unique hash 273 that identifies the node 269. The authorization system 219 could also select one or more items of information to store as initial transaction details 263 in the node 269, such as the total amount of the transaction, the date and time of the transaction, and potentially other information.

After creating the node 269, the authorization system 219 can store the node 269 in the distributed ledger 209 or cause the node 269 to be stored in the distributed ledger 209 at block 411. For instance, if the distributed ledger 209 provides for or implements a distributed agent 279, then the authorization system 219 can provide the hash 273 and any relevant transaction details 263 as arguments to the distributed agent 279, which would then store the information in the distributed ledger 209 as a node 269 in a relevant transaction graph 266. In some implementations where the distributed agent 279 is tasked with encrypting updates to the nodes 269 stored in the distributed ledger 209, the authorization system 219 could provide the distributed agent 279 with a copy of the appropriate public key 226.

Proceeding to block 413, the authorization system 219 can create a transaction processing record 229 representing the transaction. This can include a transaction identifier 236 that uniquely identifies the transaction, the account identifier 243 of the account used for the transaction, the merchant identifier 239 of the merchant that requested authorization of the transaction, and the transaction status 246. The transaction processing record 229 is then stored in the transaction processing data store 223.

Then at block 416, the authorization system 219 can return the transaction status 246 to the merchant system 253. For example, if the transaction were approved, then the authorization system 219 would return a transaction status 246 indicating that the transaction had been approved. In some implementations, the authorization system 219 can also provide a transaction identifier 236 in the response. Likewise, in those implementations where the distributed agent 279 is not responsible for encrypting updates to the nodes 269 in the distributed ledger 209, the authorization system 219 can also provide a copy of the public key 226 to be used by the merchant system 253 for updating the node 269. In other implementations, a copy of the public key 226 may not be provided in the response. In these implementations, the public key 226 can instead be distributed through other communication channels to the merchant system 253.

Next at block 419, the merchant system 253 can update the node 269 by storing additional transaction details 263 in the node 269. For example, if the distributed ledger 209 implements or provides for a distributed agent 279, the merchant system 253 could provide the transaction details 263 to the distributed agent 279, which would then update the node 269. Accordingly, the merchant system 253 could compute the hash 273 that identifies the node 269 and provide the hash 273 to the distributed agent 279 as an argument to allow the distributed agent 279 to update the appropriate node 269 in the appropriate transaction graph 266. In some implementations, the merchant system 253 can encrypt the transaction details 263 using the public key 226 prior to storing the transaction details 263 in the distributed ledger 209.

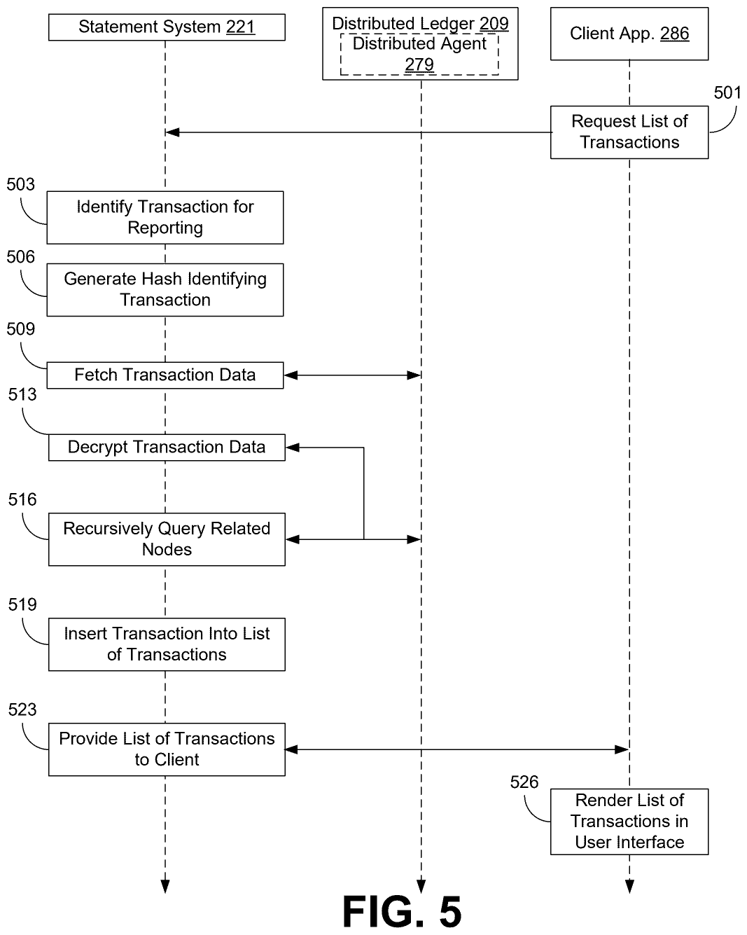

Referring next to FIG. 5, shown is a sequence diagram that provides one example of the interaction between various components of the network environment 200. It is understood that the flowchart of FIG. 5 provides merely an example of the many different types of functional arrangements that can be implemented in the network environment 200. As an alternative, the flowchart of FIG. 5 can be viewed as depicting an example of elements of a method implemented within the network environment 200.

Beginning with block 501, in some instances, the client application 286 can send a request to the statement system 221 for a list of transactions 103. For example, a user of the client application 286 could cause the client application 286 to send a request to view transactions in a particular statement period. However, in some instances, the statement system 221 may begin operation without receiving a request from the client application 286. For example, the statement system 221 could be configured to implement the following process on a monthly basis.

Next at 503, the statement system 221 can identify a transaction to include in a report or otherwise prepare for reporting. For example, the statement system 221 could select a transaction in response to specific request to view the transaction. As another example, the statement system 221 could select a transaction in response to a request to compile data about multiple transactions (e.g., for preparation or inclusion in a monthly bill or a monthly, quarterly, or yearly report).

Then at block 506, the statement system 221 can generate a hash 273 that identifies the node 269 that represents the transaction. In simple implementations, the transaction identifier 236 could be used as a substitute for the hash 273 or as the basis for the hash 273 (e.g., as an argument to a cryptographic hash function). In more complex implementations, additional arguments from the respective transaction processing record 229 or account record 233 could be supplied to a cryptographic hash function. For example, the transaction identifier 236, account identifier 243, and/or account holder 249 (e.g., first and last name) could be concatenated together as an argument for a cryptographic hash function. Similarly, the transaction identifier 236, account identifier 243, and/or account holder 249 could be used to form a tuple that serves as the hash 273.

Moving to block 509, the statement system 221 can fetch transaction details 263 and other data related to a transaction from the distributed ledger 209. For example, the statement system 221 could generate a hash 273 that identifies a node 269 of a transaction graph 266 that stores information about the transaction. The statement system 221 could then use the hash 273 as a key to retrieve the node 269 from the distributed ledger 209. For instance, if the distributed ledger 209 provides for or implements a distributed agent 279, the statement system 221 could provide the hash 273 to the distributed agent 279 and receive the transaction details 263 in response. The transaction details 263 can potentially include a list of linked node hashes 276 to other nodes 269 that contain additional transaction details 263 regarding the transaction.

The hash 273 could be generated in a number of ways based at least in part on the information stored in the transaction processing record 229 associated with a given transaction. For example, the tuple formed by a number of parameters related to the transaction (e.g., transaction identifier 236, account identifier 243, account holder 246, etc.) could be used as a hash 273 for a transaction. As another example, the parameters related to the transaction could be concatenated together to form an input for a cryptographic hash function that would generate a unique hash 273 that identifies the node 269.

Then at block 513, the statement system 221 can decrypt the information stored in the node 269 that was retrieved from the distributed ledger 209. For example, the statement system 221 could use a private key 227 for a respective public key 226 to decrypt the information stored in the node 269.

Next at block 516, the statement system 221 can recursively query the distributed ledger 209 for additional nodes 269 that are related to the node 269 retrieved at block 509. For example, the statement system 221 could identify the hashes 273 identified in the list of linked node hashes 276. For each additional hash 273 in the list of linked node hashes 276, the statement system 221 could query the distributed ledger 209 for the respective node 269 and decrypt the information using the process previously described in blocks 509 and 513.

Moving on to block 519, the statement system 221 can insert or otherwise add the transaction to the list of transactions 103 that will be presented to the user. Accordingly, the statement system 221 could, for each transaction processing record 229 associated with a transaction identifier 236, insert an entry that identifies the merchant with which a transaction was conducted, the date and amount of the transaction, and any transaction details 263 that had been stored by the merchant in the distributed ledger (e.g., an itemized breakdown of the transaction).

Moving on to block 523, the statement system 221 can provide the list of transactions 103 to the user. For example, if a user of a client device 213 used a client application 286 to request a list of transactions 103, the statement system 221 could provide the list of transactions 103 in response. This could be, for instance, a list of transactions 103 that have occurred during a particular period of time (e.g., since the last statement, or during a particular statement period). As another example, the statement system 221 could cause the list of transactions 103 to be sent to a printing system for physical delivery to the user, such as when a monthly or quarterly statement is mailed to a user.

In those instances where a user of a client device 213 had request a list of transactions 103, the client device 213 can cause the list of transactions 103 to be presented within a user interface 100 rendered on a display 283 of the client device 213 at block 526. For example, the client application 286 (e.g., a web browser, dedicated banking application on mobile device, etc.) could receive the list of transactions 103 and format them for viewing within the user interface 100. Accordingly, this could also be considered as the statement system 221 displaying the list of transactions 103 or causing the list of transactions 103 to be displayed.

A number of software components previously discussed are stored in the memory of the respective computing devices and are executable by the processor respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, further cause the computing device to at least:
compute a hash for a node in a graph, the hash being based at least in part on a transaction identifier;
retrieve transaction information from the node in the graph identified by the hash; and
insert a transaction into a list of transactions, the transaction comprising the transaction information retrieved from the node.

2. The system of claim 1, where in the node is a first node and the machine-readable instructions further cause the computing device to at least:
identify a second node in the graph that is linked to the first node;
retrieve additional transaction information from the second node; and
the transaction inserted into the list of transactions further comprises the additional transaction information retrieved from the second node.

3. The system of claim 1, wherein the machine-readable instructions, when executed by the processor, further cause the computing device to at least prepare a transaction statement that comprises the list of transactions and the transaction information from the node in the graph identified by the hash.

4. The system of claim 1, wherein the graph is stored in a distributed ledger.

5. The system of claim 1, wherein the machine-readable instructions that cause the computing device to retrieve transaction information from the node in the graph identified by the hash further cause the computing device to at least:
provide the hash of the node to a distributed agent executed by the distributed ledger; and
receive the transaction information from the distributed agent in response.

6. The system of claim 1, wherein the machine-readable instructions, when executed by the processor, further cause the computing device to at least decrypt the transaction information in response to retrieval of the transaction information from the node in the graph identified by the hash.

7. The system of claim 1, wherein the hash is further based at least in part on an account number associated with the transaction identifier.

8. A method, comprising:
computing a hash for a node in a graph, the hash being based at least in part on a transaction identifier;
retrieving transaction information from the node in the graph identified by the hash; and
inserting a transaction into a list of transactions, the transaction comprising the transaction information retrieved from the node.

9. The method of claim 8, where in the node is a first node and the method further comprises:
identifying a second node in the graph that is linked to the first node;
retrieving additional transaction information from the second node; and
the transaction inserted into the list of transactions further comprises the additional transaction information retrieved from the second node.

10. The method of claim 8, further comprising preparing a transaction statement that comprises the list of transactions and the transaction information from the node in the graph identified by the hash.

11. The method of claim 8, wherein the graph is stored in a distributed ledger.

12. The method of claim 8, wherein retrieving transaction information from the node in the graph identified by the hash further comprises:
providing the hash of the node to a distributed agent executed by the distributed ledger; and
receiving the transaction information from the distributed agent in response.

13. The method of claim 8, further comprising decrypting the transaction information in response to retrieving transaction information from the node in the graph identified by the hash.

14. The method of claim 8, wherein the hash is further based at least in part on an account number associated with the transaction identifier.

15. A non-transitory, computer-readable medium, comprising machine-readable instructions that, when executed by a processor of a first computing device, cause the computing device to at least:
send an authorization request for a transaction to a second computing device;
receive a transaction authorization from the second computing device, the transaction authorization comprising a transaction identifier;
compute a hash that identifies a node in a graph stored in a distributed ledger, the node representing the transaction; and
store a transaction detail in the node identified by the hash.

16. The non-transitory, computer-readable medium of claim 15, wherein the machine-readable instructions that cause the computing device to store the transaction detail in the node identified by the hash further cause the computing device to at least invoke a distributed agent implemented by a distributed ledger to

17. The non-transitory, computer-readable medium of claim 16, wherein the machine-readable instructions that cause the first computing device to store the transaction detail in the node identified by the hash further cause the first computing device to at least provide the hash and the transaction detail to the distributed agent implemented by the distributed ledger.

18. The non-transitory, computer-readable medium of claim 15, wherein the machine-readable instructions that cause the first computing device to store the transaction detail in the node identified by the hash further cause the first computing device to at least provide the transaction identifier to the distributed agent included in the node.

19. The non-transitory, computer-readable medium of claim 15, wherein the machine-readable instructions further cause the first computing device to encrypt the transaction detail prior to storage of the transaction detail in the node.

20. The non-transitory, computer-readable medium of claim 15, wherein the transaction comprises a purchase of a plurality of items and the transaction detail comprises a description and a price of each of the plurality of items purchased.
